(19) United States
(12) Patent Application Publication
(10) Pub. No.: US 2015/0310521 A1
(43) Pub. Date: Oct. 29, 2015

(54) ELECTRONIC SYSTEM WITH CONTENT MECHANISM AND METHOD OF OPERATION THEREOF

(71) Applicant: Samsung Electronics Co., Ltd., Suwon-si (KR)

(72) Inventors: Dion Isselhardt, Saratoga, CA (US); Stacie Lynn Hibino, San Jose, CA (US); Suranjit Adhikari, San Jose, CA (US); Dhana Dhanasarnsombat, San Jose, CA (US)

(73) Assignee: Samsung Electronics Co., Ltd., Suwon-si (KR)

(21) Appl. No.: 14/264,871

(22) Filed: Apr. 29, 2014

(51) Int. Cl. G06Q 30/06

(52) U.S. Cl. CPC G06Q 30/0621

(57) ABSTRACT

An electronic system includes: a storage unit configured to create a card, a storage unit configured to create a card, a communication unit, coupled to the control unit, configured to transfer the card.

### TECHNICAL FIELD

An embodiment of the present invention relates generally to an electronic system, and more particularly to a system for content.

### BACKGROUND

Modern consumer and industrial electronics, especially devices such as graphical display systems, televisions, projectors, cellular phones, portable digital assistants, and combination devices, are providing increasing levels of functionality to support modern life. Research and development in the existing technologies can take a myriad of different directions.

These electronic devices can display information including statistics, pictures, gift cards, or retail purchase. The information is intended for a user of the device with a specific time or location, for advertising or location based information. This advertising or location based information is increasing popular and can include a card metaphor.

Some cards such as trading cards can be created by connecting to an internet site, selecting a custom feature, entering any personalized information, indicating destination information, and printing the trading card with the custom feature and the personalized information if entered.

Thus, a need still remains for an electronic system with content mechanism for enhanced or specialized content. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a storage unit configured to create a card, a storage unit configured to create a card, a communication unit, coupled to the control unit, configured to transfer the card.

An embodiment of the present invention provides a method of operation of an electronic system including: creating a card (304); assigning a valuation (324), with a control unit, to the card (304) and transferring the card (304).

An embodiment of the present invention provides a non-transitory computer readable medium including stored thereon instructions to be executed by a control unit comprising, including: creating a card (304); assigning a valuation (324) to the card (304) and transferring the card (304).

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system with content mechanism in an embodiment of the present invention.

FIG. 2 is an exemplary block diagram of the electronic system.

FIG. 3 is a control flow of the electronic system in an exemplary embodiment.

FIG. 4 is a plan view with sample displays of the electronic system in an exemplary embodiment.

FIG. 5 is a plan view with sample displays of the electronic system in an exemplary embodiment.

FIG. 6 is a plan view with sample displays of the electronic system in an exemplary embodiment.

FIG. 7 is a plan view with sample displays of the electronic system in an exemplary embodiment.

FIG. 8 is a plan view with sample displays of the electronic system in an exemplary embodiment.

FIG. 9 is a plan view with sample displays of the electronic system in an exemplary embodiment.

FIG. 10 is a flow chart of a method of operation of an electronic system in an embodiment of the present invention.

### DETAILED DESCRIPTION

An embodiment of the present invention includes a novel system and method for creating, valuating, updating and presenting thematic digital cards and collections including a combination of cards based on themes such as athletes, sports teams, museum exhibitions, concerts, personal memories, other themes, or combination thereof.

Some digital cards display gift cards and other retail purchase information in a card metaphor but do not dynamically update or are not persistent. Other digital cards have a card metaphor for contextual notification, but do not persist and are non-shareable.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

One skilled in the art would appreciate that the format with which image information is expressed is not critical to some embodiments of the invention. For example, in some embodiments, image information is presented in the format of (X, Y); where X and Y are two coordinates that define the location of a pixel in an image.

In an alternative embodiment, three-dimensional image information is presented by a format of (X, Y, Z) with related information for color of the pixel. In a further embodiment of the present invention, the three-dimensional image information also includes an intensity or brightness element.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

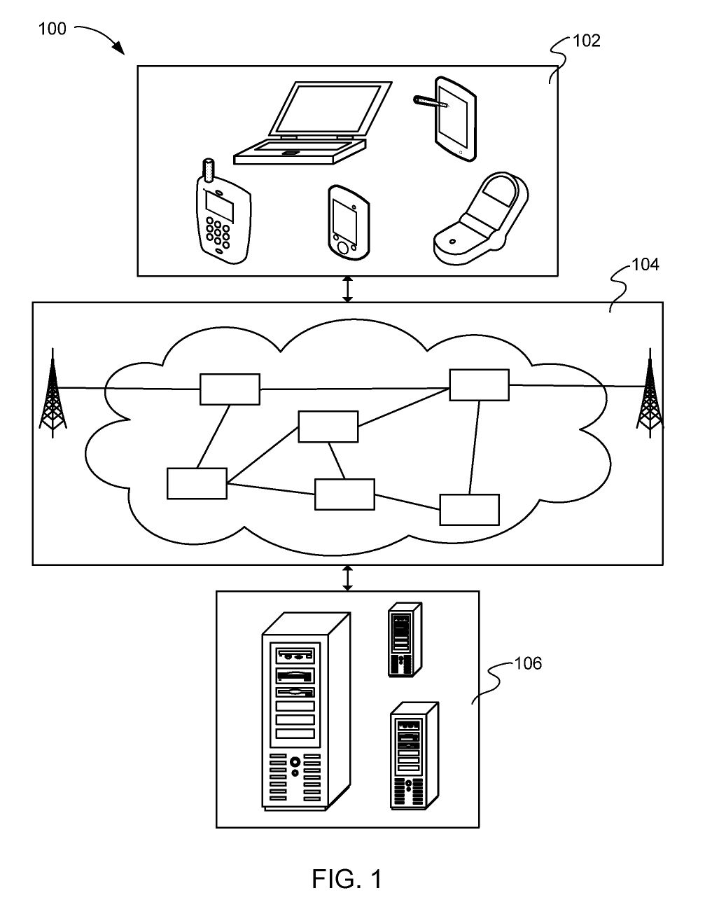

Referring now to FIG. 1, therein is shown an electronic system 100 with content mechanism in an embodiment of the present invention. The electronic system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the electronic system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the electronic system 100 is described with the second device 106 as a computing device, although it is understood that the second device 106 can be different types of devices. Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

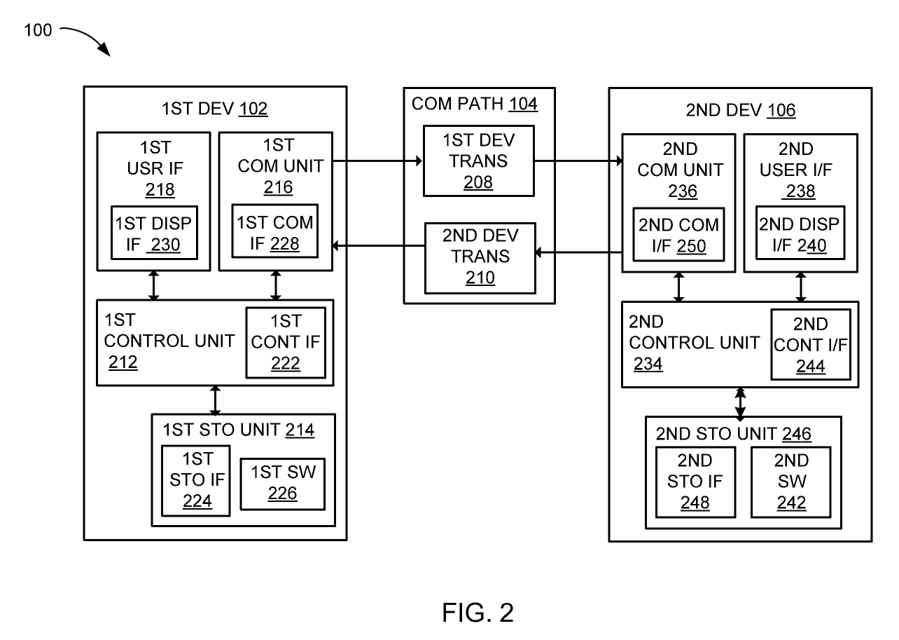

Referring now to FIG. 2, therein is shown an exemplary block diagram of the electronic system 100. The electronic system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server having a display interface.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the electronic system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 102. For example, the first communication unit 216 can permit the first device 102 to communicate with the second device 106 of FIG. 1, an attachment, such as a peripheral device or a computer desktop, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include a display, a projector, a video screen, a speaker, or any combination thereof.

The first control unit 212 can operate the first user interface 218 to display information generated by the electronic system 100. The first control unit 212 can also execute the first software 226 for the other functions of the electronic system 100. The first control unit 212 can further execute the first software 226 for interaction with the communication path 104 via the first communication unit 216.

The second device 106 can be optimized for implementing an embodiment of the present invention in a multiple device embodiment with the first device 102. The second device 106 can provide the additional or higher performance processing power compared to the first device 102. The second device 106 can include a second control unit 234, a second communication unit 236, and a second user interface 238.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the electronic system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the electronic system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is external to the second device 106.

The second controller interface 244 can receive information from the other functional units or from external sources, or can transmit information to the other functional units or to external destinations. The external sources and the external destinations refer to sources and destinations external to the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the electronic system 100 is shown with the second storage unit 246 as a single hierarchy storage system, although it is understood that the electronic system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The electronic system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100.

The modules described in this application can be implemented as instructions stored on a non-transitory computer readable medium to be executed by a first control unit 212, the second control unit 234, or a combination thereof. The non-transitory computer medium can include the first storage unit 214, the second storage unit 246, or a combination thereof. The non-transitory computer readable medium can include non-volatile memory, such as a hard disk drive (HDD), non-volatile random access memory (NVRAM), solid-state storage device (SSD), compact disk (CD), digital video disk (DVD), universal serial bus (USB) flash memory devices, Blu-ray Disc™, any other computer readable media, or combination thereof. The non-transitory computer readable medium can be integrated as a part of the electronic system 100 or installed as a removable portion of the electronic system 100.

Modules in this application can be hardware implementation, hardware circuitry, or hardware accelerators in the first control unit 212 or in the second control unit 234. The modules can also be hardware implementation, hardware circuitry, or hardware accelerators within the first device 102 or within the second device 106 but outside of the first control unit 212 or the second control unit 234, respectively.

Modules in this application can be at least a part of the first software 226, the second software 242, or a combination thereof. These modules can also be stored in the first storage unit 214, in the second storage unit 246, or a combination thereof. The first control unit 212, the second control unit 234, or a combination thereof can execute these modules for operating the electronic system 100.

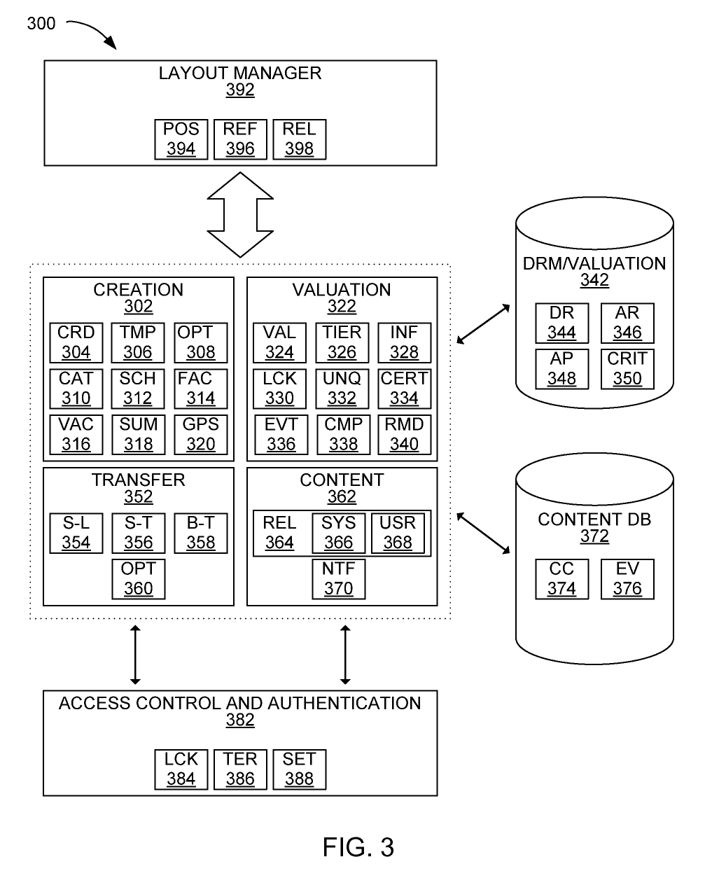

Referring now to FIG. 3, therein is shown a control flow 300 of the electronic system 100 in an exemplary embodiment. The control flow 300 can provide layout, creation, valuation, transfer, access, authentication, other content functions, or combination thereof.

A creation module 302 can include a card 304, card templates 306, card options 308, card categories 310, or combination thereof. The cards 304 can be created by a creator such as an individual user, collectively by a group of users, automatically generated by the creation module 302, or combination thereof. The creation module 302, such as a card generator, can provide the card templates 306, a search module 312 with a search function, and the card options 308, for creating cards 304.

The card 304 can be generated automatically based on factors 314 such as a user profile, content consumption pattern, interest, preferences, past events, upcoming events, other factors, or combination thereof. The cards 304 can be created automatically by contextual algorithms, collaboratively, user input of preferences such as favorite player, team, city, or combination thereof.

The veracity and authenticity of content of the card 304 can be ensured by varying encryption, context, peer reviews, or combination thereof. Custom creation of the cards 304 can be based on user preference. Unique, limited editions of the cards 304 can be created or issued and can include various kinds of different metadata. The card 304 can include sports, athletes, personal interests, hobbies, vacation information such as a vacation digital footprint 316, or combination thereof.

The user or group of users can create the card 304 with the creation module 324 and a search by the search module 312 for specific terms such as an athlete or teams. Also, the user or the group of users can create the card 304 with selection of the card options 308 and the categories 310 such as favorites, trending, athletes, teams, events, or combination thereof, for creating the card 304 such as an über card 304 or a superlative card 304. The über card 304 or the superlative card 304 can include unique multi-dimensional characteristics such as the first 100 concert tickets purchased include behind-the-scenes footage.

The card templates 306 can contain the card options 308 such as default card options 308 based on the card templates 306. For example, an “Athlete” template can provide the default card options 308 including navigation through a UI with selection of a sport of interest and selection of an athlete based on the sport of interest. Further, the default card options 308 can include default information, described further in the description of a content updater below, such as an athlete's basic statistics, mini cards, or combination thereof, and can be linked to the card 304 being created.

A collection of the cards 304 can be created by selecting the cards 304 associated with a category 310, an interest, a theme, a specific term, a keyword, or combination thereof, for the collection. The creator can manually gather all available cards of interest or the system can help automatically create a collection, for finding cards matching the creator's intent based on keywords or other descriptions. The creation module 302 can generate a summary 318 describing the collection. The electronic system 100 with the summary 318, can also recommend additional of the cards 304 or highlight relevant information within the card 304 to provide an overview of the card collection and highlight of important features for the card collection.

A valuation module 322 can request and receive a valuation 324 such as interest in the cards 304, as well as policies, rights, or combination thereof, from a rights or valuation server described below. The valuation module 322 such as a card valuator 322, can monitor and manage the valuation 324 such as a value 324 or a card value 324, of the cards 304. The card value 324 may increase or decrease based on information contained in a card.

The valuation module 322 can assign the valuation 324 to each of the cards 304 based on specific criteria, allowing users, including card owners, buyers, traders, or combination thereof, to determine the valuation 324 for the card 304, or combination thereof. The valuation module 322 can also automatically evaluate strength of the card 304 and the valuation 324 based on content stored, demand of content, uniqueness, availability, or combination thereof.

The valuation module 322 can assign a tier 326 to the cards 304 or the collection of the cards 304. The tier 326 can also be assigned based on a status of a creator, an owner, other criteria, or combination thereof, for the card 304. The tier 326 can also be based on the card 304 including special information 328 such as news, insider information, certification, special events, social media updates, other information, or combination thereof.

For example, a card 304 for an athlete can be assigned the tier 326 of Golden status based on creation by the athlete, creation by the athlete's manager, creation by the athlete's agent, certification by a card owner for credibility or uniqueness of content source, or combination thereof. Different of the tiers 326 can also be assigned to one or more of the cards 304 having the same content and format for enabling special features.

For example, the card 304 with special information 328 pertaining to an athlete's unpublicized injury can be assigned the tier 326 of Bronze status. The tier assignment can also be linked to how the card 304 is used. Further to the example, the card 304 can be used for a Fantasy Draft with secrecy and importance of injuries providing the tier 326 of Golden status assigned to the card 304 due to importance of information related to the Fantasy Draft. Based on a predetermined level of the tier 326, a locking module 330 can trigger unlocking of special features. For example, the tier 326 of the Golden status may provide a cardholder with a one-on-one experience with athletes that can further increase the card value 324.

The locking module 330 can lock or unlock content updates based on special events, determination of the uniqueness, determination of completeness, user action, user follow-up activities, or combination thereof. An auto archiving feature can provide lock down of the cards 304 with dynamic content based on criteria such as the special events, the uniqueness, the completeness, or combination thereof, including end of a season, end of a player's career, or combination thereof, to ensure completeness of the content within the card. The lock down can apply to one of the cards or a collection of the cards 304 including corresponding appropriate content.

The valuation module 322 can include process components for providing, determining, creating, improving, assessing, handling, recommending, or combination thereof, factors or criteria for the valuation 324. The process components can include a uniqueness module 332, a certification module 334, an event handler module 336, a completeness module 338, a recommendation module 340, or combination thereof.

A uniqueness identifier process of the uniqueness module 332 can determine a uniqueness of contents of the card 304. The uniqueness module 332 may impose limits on the number of the cards 304, the number of topics of a card, or the number of the cards 304 in a collection. The uniqueness module 332 can determine or assess unique, limited edition cards issued with various types of different metadata.

For example, the cards 304 for a special event can be provided to the first ten people who attend a particular event, such as a game, with each of the cards 304 containing different information such as owner identity, serial number, seating position, other information, or combination thereof. These special editions of the cards 304 can include implicit or explicit special metadata such as GPS stamps that cannot be edited by a user. The uniqueness module 332 can also limit a number of the cards 304 that can be created for a specific topic or a specific one of the category 310. For example, a limit of one thousand (1000) of the cards 304 can be created for a specific athlete.

The uniqueness module 332 coupled to the creation module 302 can also create special editions of the cards 304 such as embedding features that can only be opened when specific events occur. The uniqueness module 332 coupled to the creation module 302 can also provide an individual or group, such as a sports team, means to create, distribute, authorize, or combination thereof, special editions of the cards 304. These special editions of the cards 304 can provide access to privileges, options, controls, or combination thereof, based on participation in specific events and can also provide increased access for increased participation.

For example, the uniqueness module 332 can provide a special edition if the card 304 for fans who attend a specific game and contain a game day ad-on such as a coupon for the fans that perform a qualifying activity to gain access to or unlock the coupon feature. Further to the example, the qualifying activity can require the fan holding the card 304 to go to a particular location within half an hour of the specific game ending, or to be the tenth person to enter a stadium.

The certification module 334 with the uniqueness module 332 can certify the cards 304 for special event. The certification module 334 may certify with a global positioning system (GPS) stamp 320, an event stamp, any other authentication method, or combination thereof. The valuation module 322 with the certification module 334 and the uniqueness module 332 can determine the value 324 of the cards 304.

For example, the certification module 334 can provide each special edition of the cards 304 with one or more certifications, such as special information 328, that require a cardholder to perform different qualifying activities to unlock each of the certifications such as special information 328. The valuation module 322 can adaptively adjust a value 324 of the card 304 such as based on a number of certifications or special information 328 unlocked. The valuation module 322 can also change a value 324 of the card 324 based on an importance of an event such as the special information 328 captured by the card 304.

Each of the cards 304 can be certified and authenticated based on an authentication process of the certification module 334. The locking module 330 can unlock certification based on user or owner tasks and actions. The unlocking of certification can increase or decrease valuation based on the special information 328 associated with the certification.

The event handler module 336 can provide a nature and an occurrence of an event and can also recommend determination of the event importance. The valuation module 322 may adjust the value 324 of the card 304 based on a cardholder's activities related to the event. The card 304 can be notified of real-time events and the card 304 can be updated based on either registered event filters or automatically generated. The updated content of the card 304 can increase the value of the card 304 based on the real-time event or significance of the event.

For example, the valuation module 322 can determine that the three-year closure of San Francisco Museum of Modern Art (SF MOMA) is a landmark event and the card 304 with content about visits to the SF MOMA before the closure can significantly increased value. Further to the example, a cardholder attendance at the SF MOMA count down event can receive a special event stamp for the card, which further increases the value. The event module 336 with the certification module 334 can certify a cardholder's attendance at specific events and interact with the valuation module 322 to update a value 324 for the card 304.

The completeness module 338 can assess the completeness of a collection of the cards 304. The completeness may change the value 324 of the card 304 or the collection of the cards 304, based on the valuation module 322 determination of the value 324 of a collection of the cards 304 or the card 304. The completeness module 338 can determine completeness based on physical status of the cards 304, event add-ons of the cards 304, other factors of the cards 304, or combination thereof.

For example, a collection of the cards 304 for a specific athlete contains all but one of the specific athlete's games can be determined close to complete with regard to games if the specific athlete retires. The completeness module determination that the collection is close to complete with regards to the specific athlete's games can result in the valuation module 322 providing a high value for the collection of the cards 304.

The recommendation module 340 can notify or push a recommendation to an owner of a collection of the cards 304 with the card 304 or the cards 304 missing, that a card trader has the card 304 or cards 304 that are missing. The valuation system 322 can provide a value 324 of the card trader's card that is a lower value for most others, but a much higher value for the owner of the collection of the cards 304 with the card 304 or the cards 304 missing.

The recommendation module 340 can provide notification of events that can increase the value 324 of the card 304. The valuation module 322 can change the valuation 324 based on the recommendation module 340 notification of a trading partner's collection of the cards 304, interest in the cards 304, or combination thereof. The recommendation module 340 can recommend content described further in the description of a content updater below or additional of the cards 304 to provide supplemental information such as special information 328 based on a theme of the card 304, a theme of a collection of the cards 304, or combination thereof.

The recommendation module 340 can recommend upcoming events for adding the special information 328 to the cards, completing the card 304, completing a collection of the cards 304, increasing uniqueness of the cards 304, increasing uniqueness based on recognized special status, increasing uniqueness based on a theme of the card 304, adding to a user collection pattern of the cards 304, or combination thereof. The upcoming events can also include opportunities for loaning, sharing, trading, buying, selling, or combination thereof.

For example, the recommendation module 340 such as a card manager can recommend events to an owner of the card 304. The recommended events can be provided for a card to share or loan the card 304. The recommendation module 340 can provide a notification that attendance at tomorrow's ball game will add additional special event information such as the special information 328 to the card 304 for increasing the value of the card 304. The recommendation module 340 can also provide a notification that attendance at the event with the card is required in order to receive the special information 328. The recommendation module 340 can prompt to change sharing or loaning options such as sharing the card 304 but having the card 304 returned before the ball game.

A digital rights management (DRM) module 342 such as a DRM server 342, a valuation server 342, a DRM valuation server 342, or combination thereof, can provide digital rights 344, access rights 346, access policies 348, or combination thereof. The digital rights 344, the access rights 346, the access policies 348, or combination thereof, can be provided to the valuation module 322 for determining the valuation 324 of the cards 304. Valuation criteria 350 such as specific criteria, other criteria, or combination thereof, can also be provided to the valuation module 322 for determining the valuation 324 of the cards 304.

The DRM module 342 can also track the digital rights 344, the access rights 346, the access policies 348, or combination thereof, for the cards 304 including changes, updates to the digital rights 344, the access rights 346, the access policies 348. The valuation criteria 350 to determine the valuation 324 for the card 304, a collection of the cards 304, or combination thereof, can be stored by the DRM module 342 and retrieved by valuation module 322, provided to the valuation module 322, or combination thereof. Content authentication and digital rights management can prevent unintended or unauthorized duplication of the cards 304.

The DRM module 342 such as a DRM server 342, a valuation server 342, a DRM valuation server 342, or combination thereof, keeps track of all of the cards 304 issued and the access rights 346 and policies 348 associated with the cards 304. Based on a number of the cards 304 issued, user preferences, demand, or combination thereof, the DRM module 342 can validate the valuation 324 of card 304. This valuation 324 can be adjusted based on information received from an access control system further described below, which can assess a true valuation and interests for particular of the cards 304 based on a current collection of the cards 304.

The transfer module 352 can include a share-loan module 354, a sell-trade module 356, a buy-trade module 358, or combination thereof. The transfer module 352 provides or governs sharing, loaning, buying, selling, other transfer functions, or combination thereof, of the card 304 or the collections of the cards 304. The transfer module 352 can provide multiple levels, types, means, modes, or combination thereof, of content access based on modes of transfer such as temporary or permanent.

The cards 304 can be transferred permanently or temporarily. The sell-trade module 356 of the transfer module 352 provide can provide permanent transfer of the cards 304 to ensure that a previous owner no longer has access to the card 304. The sell-trade module 356 can provide permanent transfer including selling the card 304, trading the cards 304, or combination thereof. The share-loan module 354 of the transfer module 352 can provide can provide temporary transfers for temporarily sharing or loaning the card 304.

The share-loan module 354 of the transfer module 352 works with an access control system described further below, and links an owner with the card 304 even when the card 304 is in possession of and with some level of control by a recipient. The owner can maintain continuous control over the card 304 based on transfer options 360 such as sharing options chosen by the owner. The card 304 can be digitally shared, loaned, or borrowed based on the owner authorization. The share-loan module 354 can link a user account such as an owner account, with a set or collection of the cards 304.

The share-loan module 354 can also provide the highlights of relevant information within the card 304 based on the summary 318 of the creation module 302 to provide an overview of the card collection and highlight of important features for the card collection. The card 304 with highlighted text and other content within the card 304 can be shared and stored including links of an article or source of the text.

For the temporary transfer, the transfer module 352 can provide a timeline, determined by default or owner determined, limiting a time period that the card 304 can be in the recipient's possession. The owner can also provide the timeline with the user or owner account and can specify the timeline based on the recipient or group of the recipients. After the predetermined time, the share-loan module 354 can return possession and control of the card 304 to the owner.

The transfer module 352 can provide different services to the owner or recipient based on the transferring status or the transfer options 360. For example, advertisements can be provided on the card 304 with the recipient, whereas the advertisements can be disallowed on the card with the owner. For another example, the cards 304 that are shared can be provided without associated authenticating certificates, watermarks, other features, or combination thereof.

The card 304 can be loaned for the recipient to determine whether to buy or trade for the card 304. The transfer module 352, with an updater module described further below, can allow certain updates, allow all updates, disable certain updates, or disable all updates, for the card 304 on loan.

The card 304 can be shared and can continue to receive updates. The transfer options 360 can provide sharing options for updates such as providing updates for a card 304 with the recipient for obtaining more information. For example, the owner in California can share the card 304 with the recipient in New York for the recipient to attend a game at Yankee stadium and receive the special information 328 for the owner.

A content updater module 362 can provide contents for the card 304 including relevant information 364 with system information 366 such as default information 366 or system default information 366, user defined information 368, or combination thereof. The content updater module 362 can provide a notification 370. The contents of the card 304 can be based on the card 304 created by the creation module 302.

The relevant information 364 can include the mini cards of the creation module 302. The relevant information 364 such as the mini cards of the creation module 302 can include articles, video, social media content, and other materials related to a topic such a specific athlete. The mini cards associated with the card 304 being created can be updated as information changes or information becomes available.

The system information 366 can include the default information for the default card options 308 of the creation module 302. The content updater module 362 can receive, store, send, provide, or combination thereof, the system information 366 of the default card options 308.

The user defined information 368 can include the card options 308 of the creation module 302 that are user, group of users, or creator, defined or selected. The user defined information 368 can also include the transfer options 360, such as sharing options chosen by the owner, of the transfer module 352.

The content updater module 362 can send a notification 370 to a layout manager described below for changes to the system default information 366, the user defined information 368, the relevant information 364 including the mini cards, or combination thereof. The content updater module 362 can update the cards 304 in real time after the card 304 is created.

The content of the card 304 can be automatically updated when relevant events occur. The content updater module 362 coupled with the recommendation module 340 can determine the relevant information 364. The relevant information 364 may be determined according to information or criteria such as card topic, owner location, owner interests, what is trending, the summary 318 of the creation module 302, or combination thereof. For example, a card may be updated when there are changes or updates to an athlete's stat, history, news, video and/or social media.

A content database module 372 such as a content database server 372, can receive, store, send, provide, or combination thereof, the relevant information 364 of the content updater module 362. The content database module 372 can store the relevant information 364 in the content database server 372 for subsequent use and can include partnerships with content providers to create compelling content.

The content database module 372 can also include a card content 374 such as the content of the card 304 of the content updater module 362, an event 376 such as the past events, the upcoming events, the special events, the specific events, the real-time events, the landmark event, the countdown event, the recommended events, the relevant events, the events that can increase the value 324 of the card 304, or combination thereof. The card content 374 can be received, stored, sent, provided, or combination thereof, to the creation module 302, the valuation module 322, the transfer module 352, the content module 362, or combination thereof, for processing.

The card content 374 can include topically unorganized information such as highlighted information from multiple of the cards 304. The content database module 372, the creation module 302, a layout manager described below, or combination thereof, can create a scrapbook format for the topically unorganized information.

An access control module 382 such as an authentication module 382 or an access control and authentication system 382, can include an access control lock module 384 and an access control terminate module 386 for preventing future updates for a card 304. The access control lock module 384 can lock contents of the card 304 and the access control terminate module 386 for terminating updates based on lock settings 388 including criteria, thresholds, other settings, or combination thereof. The lock settings 388 can include end of a sports season, athlete changes teams, athlete no longer plays in the league, owner trades the card 304, or combination thereof.

The access control lock module 384 can lock contents of the card 304 with digital signatures, digital stamps, digital features, or combination thereof, which can include location, people in a certain proximity, event metadata for the event 374, other data, or combination thereof. The digital signatures, the digital stamps, the digital features, or combination thereof, can be created by the access control lock module 384, provided to the access control lock module 384, or combination thereof.

The access control lock module 384 can also provide a temporary lock for a card 304. For example, contents of a card 304 can be locked as of a date of sharing by an owner. In this case, a recipient can be prevented from seeing updates even if information of the card 304 is updated. Each of the cards 304 can include dynamic content that can be locked down based on the lock settings 388 including user preferences or automatically based on the lock settings 388, the system information 336 such as context, or combination thereof.

A layout manager module 392 can include a position module 394, a refresh module 396, a re-layout module 398, or combination thereof, for formatting or layout of card contents 374 particularly when updated. The position module 394, the refresh module 396, the re-layout module 398, or combination thereof, can calculate formatting or layout of the card contents 374 based on changes such as new content size. The layout manager module 392 can provide a unique presentation with content that is displayed dynamically and adjusted based on context.

The layout manager module 392 can communicate at least with the creation module 302, valuation and the content updater 362 to dynamically position, refresh, re-layout, or combination thereof, the card contents 374 based on updates. The updates or the changes can be sent or pushed to the content updater module 362 in real-time. The content updater module 362 can send the notification 370 to the layout manager module 392 to calculate or format the card 304 based on the changes or the updates such as a new content size.

It has been discovered that the electronic system 100 with the creation module 302, the valuation module 322, the transfer module 352, the transfer module 352, the content updater module 362, the digital rights management (DRM) module 342, the content database module 372, the access control module 382, and the layout manager module 392, provides a novel system and method for creating, valuating, updating and presenting thematic digital cards 304 and collections such as a combination of the cards 304 based on themes such as athletes, sports teams, museum exhibitions, concerts, personal memories, other themes, or combination thereof.

It has been discovered that the electronic system 100 with the creation module 302 can provide the card 304 with multi-dimensional characteristics including showing up-to-date stats, pre-game interviews, post-game interviews, trending articles, special offers, unique game day cards, event cards, social media, or combination thereof.

It has been discovered that the electronic system 100 with the content updater module 362 and the card 304 can incorporate direct communication, educational information, art, historical data, music playlists at concerts, interesting city locations, interesting town locations, activities, to do's, restaurants, special check-in features that unlock exciting content, special check-in features that unlock premium content, or combination thereof.

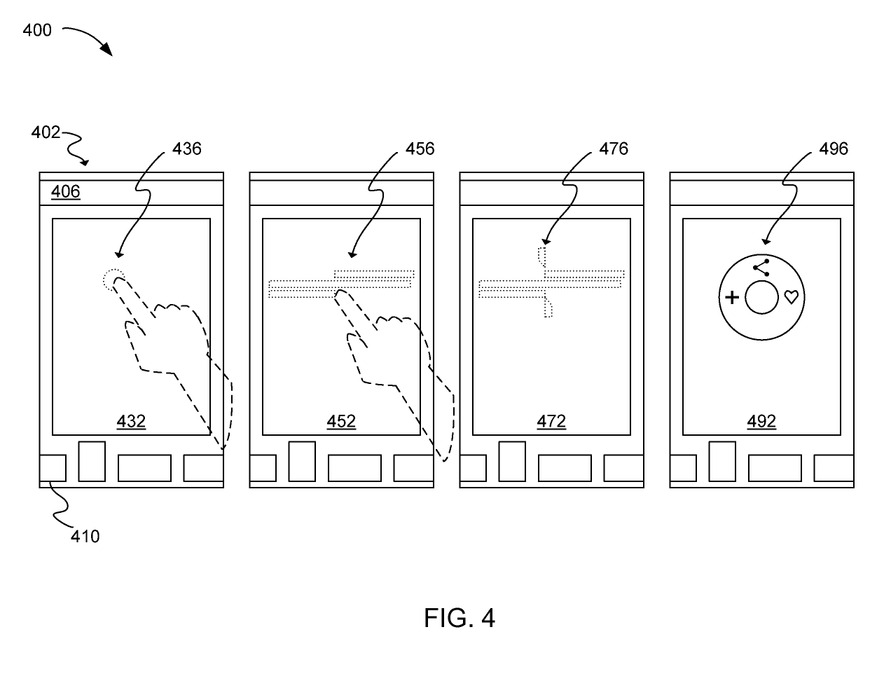

Referring now to FIG. 4, therein is shown a plan view 400 with sample displays of the electronic system 100 in an exemplary embodiment. The plan view 400 can include a display 402 such as the first display interface 230, the second display interface 240, or combination thereof. The display 402 can include a subject 406 such as an athlete's name, shortcuts 410 such as icons, symbols, text, images, widgets, or combination thereof.

A tap phase image 432 of the display 402 can include a tap region 436 such as from a finger press. The tap region 434 can initiate highlighting of a portion of the tap phase image 432. For example, a user taps a finger an article displayed on a screen.

A highlight phase image 452 of the display 402 can include a selected region 456 such as highlighted text. The highlighted region 456 can result from swipe motion such as a finger press and drag. For example, a user presses and drags a finger across selected text of the article displayed on the screen.

A handle phase 472 of the display 402 can include extensions 476 such as highlight handles. The extensions 402 can result from completing the swipe motion and can provide editing or adjusting of the highlighted region 456. For example, a user removes a finger from the screen resulting in an editing mode assisted by end marks.

An option phase 492 of the display 402 can include selection options 496 such as options for processing the highlighted region 456. The selection options 496 can result from a tap and hold on the highlighted region 456. For example, User taps and holds selection resulting in options displayed including save to über card, share, save to favorites, save to scrapbook, other selection processing, or combination thereof.

For illustrative purposes the display 402 is shown in four phases although it is understood that any number of phases may be provided. Further for illustrative purposes, only the highlighted text is shared, however, a link to an article or source of text can also be attached. Yet further highlight options are shown in a shape of a ring although it is understood that any shape or configuration can be used.

It has been discovered that the electronic system 100 with the tap phase image 432, the highlight phase image 452, the handle phase 472, the option phase 492, or combination thereof, provides sharing of the selected region 456. The tap and hold of the selected region 456 provides selection options 496 such as options for processing the highlighted region 456.

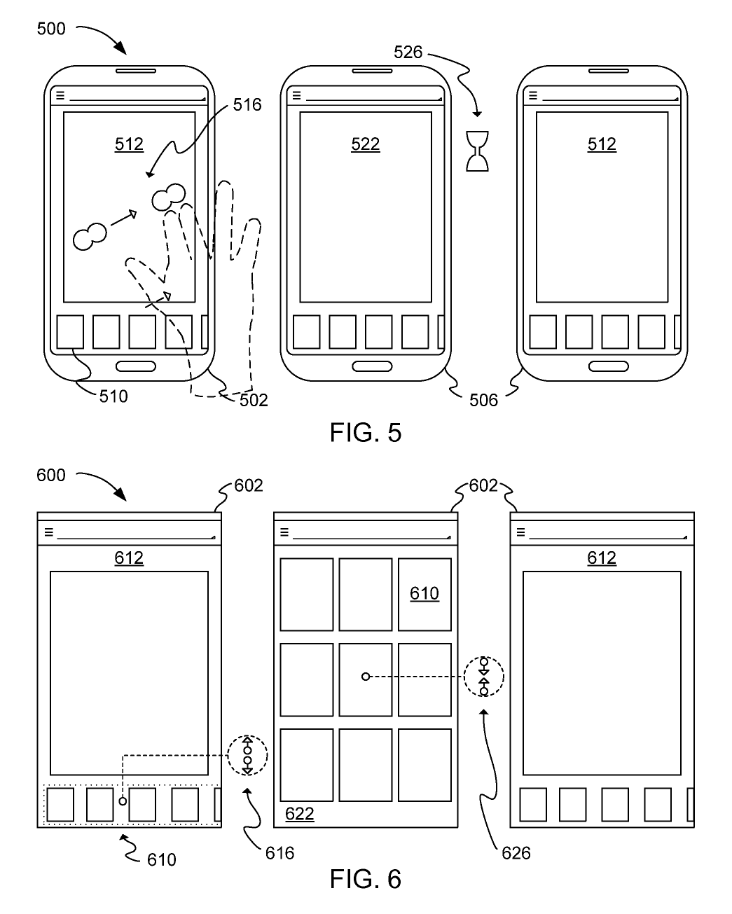

Referring now to FIG. 5, therein is shown a plan view 500 with sample displays of the electronic system 100 in an exemplary embodiment. The electronic system 100 can include an owner device 502 such as the first device 102 of FIG. 1, the second device 106 of FIG. 2, and a recipient device 506 such as the first device 102 of FIG. 1, the second device 106 of FIG. 2. The owner device 502, the recipient device 506, or combination thereof, can include shortcuts 510 such as icons, symbols, text, images, widgets, or combination thereof.

The plan view 500 can include displays such as the first display interface 230 of FIG. 1, the second display interface 240 of FIG. 1, or combination thereof, of the owner device 502, the recipient device 506, or combination thereof. The owner device 502, the recipient device 506, or combination thereof, can share the cards 304 of FIG. 3 across more than one device such as by a metaphor of flick and toss providing a user a familiar interaction paradigm.

The flick and toss metaphor to share content with another device can include a user sharing the cards 304 or the card contents 374 of FIG. 3 by a flick gesture or toss gesture. The card 304 from a deck of the cards 304 on the user's device can be flicked or tossed to another user's device. The flick gesture can be associated with an image or graphics that indicate a user flicking the card 304 from the deck of the cards 304 and tossing the card 304 to another user's device.

The flick and toss metaphor can require a specific physical proximity or distance for each of the users to complete the sharing or trading event or act. The sharing or trading can include digital object identifiers (DOI) such as with a fantasy draft for fantasy sports. The digital object identifiers can represent an athlete card and a close physical proximity can provide a connection to content in manner similar to sharing or trading physical cards.

For example an owner taps the owner device 502 to select a first image 512 representing the card 304 such as the card 304 of FIG. 3 for an athlete. The owner performs a two-finger flick 516 on the image 512 in a direction of the recipient device 506 having a second image 522. After an elapsed time 526, the recipient device 506 displays the first image 512 representing the card 304, thus sharing content via a gesture such as sharing a card with another user by using a two-finger flick gesture.

Referring now to FIG. 6, therein is shown a plan view 600 with sample displays of the electronic system 100 in an exemplary embodiment. The electronic system 100 can include a display device 602 such as the first device 102 of FIG. 1, the second device 106 of FIG. 2. The display device 602 can also include screens such as the first display interface 230 of FIG. 1, the second display interface 240 of FIG. 1, or combination thereof, with varying content density. The content density of displays on the screen can be expanded or reduced by gestures. The displays can also optionally include shortcuts 610 such as icons, symbols, text, images, widgets, or combination thereof.

For example, a user can tap the display of the display device 602 for displaying the shortcuts 610 with a default display 612. The user can apply a two-finger expand gesture 616 to the shortcuts 610 or a region of the shortcuts 610 for displaying an expanded display 622 of the shortcuts 610 such as a nine-up layout. The user can also apply a two-finger pinch gesture 626 for displaying the default display 612 thus reducing or contracting the display.

It has been discovered that the electronic system 100 provides gesturing to expand or reduce a display of a display device 602. Applying the two-finger expand gesture 616 and the two-finger pinch gesture 626 can expand and reduce the display, respectively.

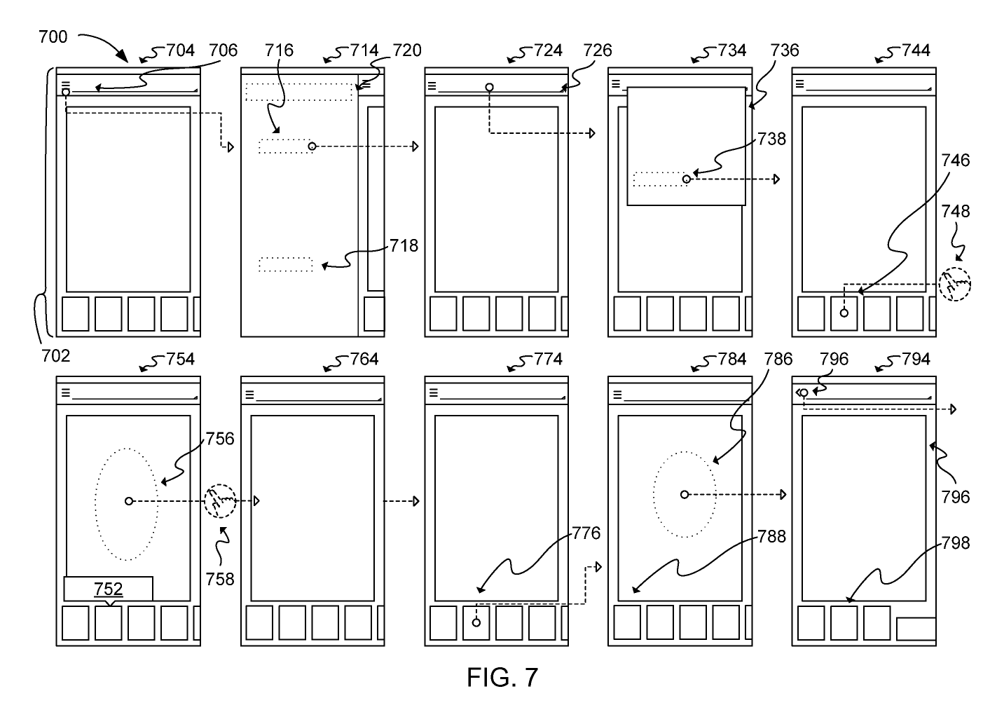

Referring now to FIG. 7, therein is shown a plan view 700 with sample displays of the electronic system 100 in an exemplary embodiment. The plan view 700 of the electronic system 100 includes a display 702 such as the first display interface 230 of FIG. 1, the second display interface 240 of FIG. 1, or combination thereof, shown in multiple phases.

A user can tap a card display 704 of the display 702. An application image 706 such as a sports card application icon, can be tapped to display the cards 304 of FIG. 3 by trending order based on popularity, value, latest update, other criteria, or combination thereof.

The user can tap a panel display 714 of the display 702 with panel icons 716 such a left panel icon. The panel icons 716 can include favorites, trends, athletes, teams, events, mixed, and an über card that has personalized highlights, content cards curated by the user, other cards, or combination thereof. A tools section 718 can provide tools or applications for adding and removing the cards 304.

A user can tap a category display 724 of the display 702 including a category 726 such as athletes. The category 726 can include all associated entries such as all athletes, all sports, all levels of sports, other associated entries, or combination thereof.

A user can tap a filter display 734 of the display 702 such as a drop down filter display 734, including a drop down window 736 with category entries 738. The category entries 738 can include all associated entries for every genre such as all athletes for every sport. Tapping on a category entry 738 of the drop down window 736 can open a genre.

A user can tap a genre display 744 of the display 702 such as an NFL football display. The genre display 744 can include genre shortcuts 746 such as associate entries for the genre including NFL athletes. A tapping motion 748 can select a genre shortcut 746.

An information bubble 752 can be displayed in a mini card display 754 of the display 702. The information bubble 752 can include additional information such as an athlete's name, breaking news, sport information, or combination thereof. Hovering over a mini card image 756 of the mini card display 754 with a hover motion 758 can provide more information.

The hover motion 758 can provide a hover display 764 of the display 702 such as a statistics display. The hover display 764 provides additional information with a larger screen region based on the selection associated with the genre shortcut 746.

Removing the hover motion 758 can return the display 702 to a default display 774 of the display 702 such as the genre display 744 or a default view based on the category entry 738 selected. For example, terminating the hover motion 758 by removing a finger or stylus from proximity of the display 702 returns the display 702 to the default display 744 such as an athlete hero shot. A tapping motion 748 on a default shortcut 776 can provide a larger view.

The tapping motion 748 of the default shortcut 776 can open an update display 784 of the display 702. The update display 784 can include a hero image 786 based on the default shortcut 776 selected. The mini card image 756 such as a previous hero image, can be placed in an update shortcut 788 such as a carousel shortcut.

Tapping on the hero image 786 opens a content display 794 of the display 702. The content display 794 can include related information 796 such as articles, video, tweets, all other related material, or combination thereof. The content display 794 can also include content shortcuts 798 that can be arranged in a time line such as a sequential trending order from left to right.

It has been discovered that the electronic system 100 with the display 702 provides a flow for basic navigation of the electronic system 100. All of the cards 304 can be provided in the panel icons 716 such as left panel buckets for “Athletes—All” to “Football—NFL”. The tapping motion 748 and the hover motion 758 can provide information on mini cards and large cards as well as detailed information on a player card.

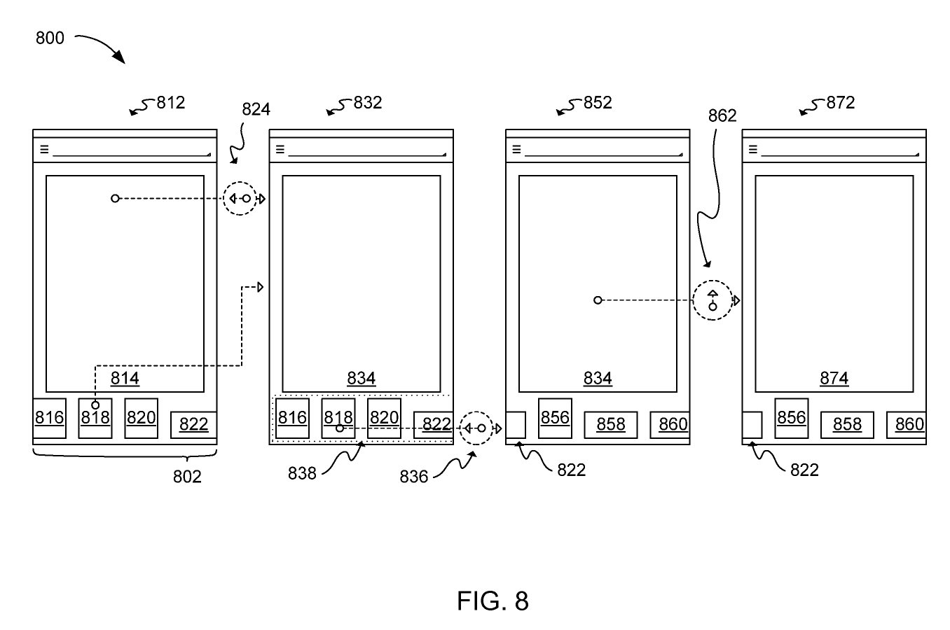

Referring now to FIG. 8, therein is shown a plan view 800 with sample displays of the electronic system 100 in an exemplary embodiment. The plan view 800 of the electronic system 100 includes a display 802 such as the first display interface 230 of FIG. 1, the second display interface 240 of FIG. 1, or combination thereof, shown in multiple phases. The display 802 can include a content image such as the card 304 of FIG. 2 and mini cards. Tapping a mini card can expand the mini card replacing the content image with a content associated with the mini card.

A first article display 812 of the display 802 can include a first article first page 814, a first article mini card 816 linked to a first informational article, a second article mini card 818 linked to a second informational article, a social media mini card 820 linked to a social media entry such as a tweet, a video mini card 822, or combination thereof. The first article mini card 816, the second article mini card 818, the social media mini card 820, the video mini card 822, or combination thereof, can be configured in a carousel like band arranged as a time line with a sequential or trending order from left to right. A swipe motion 824 can change the display 802 to a previous or subsequent page or information image.

Tapping on the second article mini card 818 can display the second article and replace the first article first page 814 with the second article first page 834 in a second article display 832 of the display 802. The second article display 832 can also include the first article mini card 816, the second article mini card 818, the social media mini card 820, the video mini card 822, or combination thereof.

A user can apply a swipe motion 836 a carousel 838 to advance the carousel 838 for displaying updated positions of the mini cards such as the first article mini card 816, the second article mini card 818, the social media mini card 820, the video mini card 822, or combination thereof.

A carousel display 852 can include the video mini card 822, a third article mini card 856 linked to a third article, a second video mini card 858 linked to a second video, another video mini card 860 linked to another video, or combination thereof. The updated mini card positions can provide visibility for older content such as the third article mini card 856, the second video mini card 858, the another video mini card 860, or combination thereof.

A user can apply a swipe motion 862 such as a bottom to top swipe or an upward swipe, to the second article first page 834 of the carousel display 852 for displaying a second page display 872. A second article second page 874 of the second page display 872 can be display with the video mini card 822, a third article mini card 856, a second video mini card 858, another video mini card 860, or combination thereof.

It has been discovered that the electronic system 100 provides a flow for navigating the card 304 and the carousel 838. The flow navigates between the first article display 812, the second article display 832, the carousel display 852, or combination thereof, for providing access to the card content 374 of FIG. 3.

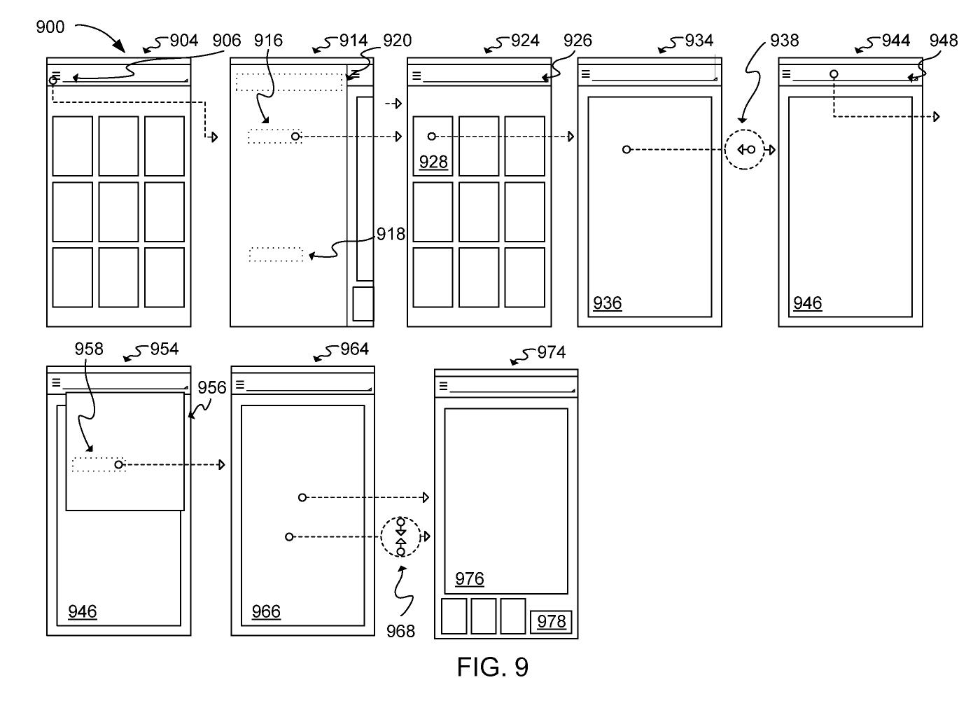

Referring now to FIG. 9, therein is shown a plan view 900 with sample displays of the electronic system 100 in an exemplary embodiment. The plan view 900 of the electronic system 100 includes a display 902 such as the first display interface 230 of FIG. 1, the second display interface 240 of FIG. 1, or combination thereof.

The display 902 does not include the carousel 838 particularly at a root level and the plan view 900 provides a flow for basic navigation without a carousel such as the carousel 838 of FIG. 8. For example, the flow for navigation can include from All sports cards to left panel buckets to “Athletes—All” to “Athlete X.” Gesturing horizontally moves between athletes, venues, or combination thereof, and tapping on the card 304 of FIG. 3 can display the card content 374 of FIG. 3, displaying a carousel. A user can drop in one level to see the carousel 838 including articles, rich media, other information, or combination thereof.

A user can tap a card display 904 of the display 902. An application image 906 such as a sports card application icon, can be tapped to display the cards 304 by trending order based on popularity, value, latest update, other criteria, or combination thereof.

The user can tap a panel display 914 of the display 902 with panel icons 916 such a left panel icon. The panel icons 916 can include favorites, trends, athletes, teams, events, mixed, and an über card that has personalized highlights, content cards curated by the user, other cards, or combination thereof. A tools section 918 can provide tools or applications for adding and removing the cards 304. A search window 920 can be at a top of a panel.

A user can tap a category display 924 of the display 902 including a category 926 such as athletes. The category 926 can include all associated entries such as all athletes, all sports, all levels of sports, other associated entries, or combination thereof, displayed in a trending order.

A user can tap a category image 928 such as an icon of an athlete, to display a card display 934 of the display 902. The first card display 934 can display a first card image 936 such as an athlete card.

Applying a swipe motion 938 such as a right to left swipe, displays a second card image 946 such as another athlete card. A second card identifier 948 such as an athlete name, can be displayed on a top portion of the second card display 944 of the display 902.

A user can tap the second card identifier 948 to display a filter display 954 of the display 902. The filter display 954 can include a drop down window 956 over the second card image 946. The drop down window 956 of a filter display 954 can include category entries 958. The category entries 958 can include all associated entries such as athletes.

Tapping on a category entry 958 of the drop down window 956 can open a third card display 964 of the display 902. The third card display 964 can include a third card image 966 such as yet another athlete card. A pinching motion 968 on the third card image 966 can return the display 902 to the category display 924. Tapping the third card image 966 can display a content display 974 of the display 902. The content display 974 can include recent content 976 such as a most recent article for the yet another athlete card. The content display 974 can also include content mini cards 978 such as articles, video, social media such as tweets, other related material, or combination thereof. The mini cards 978 can be arranged or configured in a sequential trending order such as from left to right.

It has been discovered that the electronic system 100 provides navigation without a carousel such as the carousel 838. Gesturing horizontally moves between athletes, venues, or combination thereof, and tapping on the card 304 of FIG. 3 can display the card content 374 of FIG. 3. A user can drop in one level to see the carousel 838

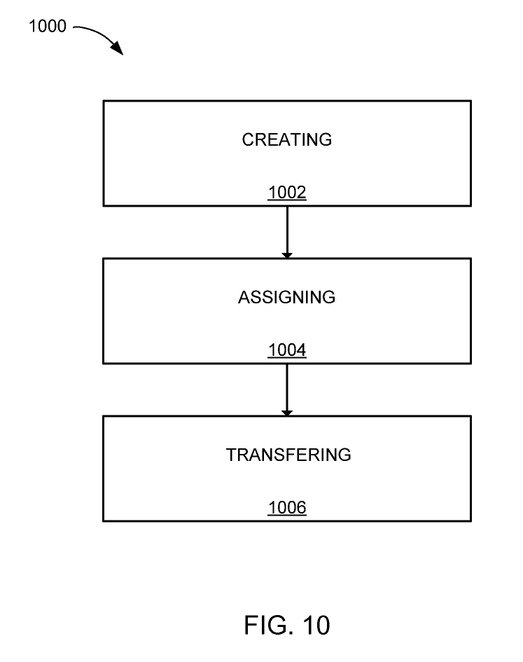

Referring now to FIG. 10, therein is shown a flow chart of a method 900 of operation of an electronic system 100 in an embodiment of the present invention. The method 1000 includes: creating a card in a block 1002; assigning a valuation, with a control unit, to the card in a block 1004; and transferring the card in a block 1006.

All of the modules herein can be implemented as hardware, hardware circuitry, or hardware accelerators with the first control unit 212 or with the second control unit 234. The modules can also be implemented as hardware, hardware circuitry, or hardware accelerators with the first device 102 or with the second device 106, and outside of the first control unit 212 or the second control unit 234, respectively.

All or at least a portion of the modules herein can be included in the first software 226, the second software 242, or a combination thereof. All or at least a portion of the modules herein can also be included in the first storage unit 214, the second storage unit 246, or a combination thereof. The first control unit 212, the second control unit 234, or a combination thereof can execute all of the modules for operating the electronic system 100.

The creation module 302 of FIG. 3 can be coupled to the valuation module 322 of FIG. 3, the transfer module 352 of FIG. 3, the content updater module 362 of FIG. 3, the digital rights management (DRM) module 342 of FIG. 3, the content database module 372 of FIG. 3, the access control module 382 of FIG. 3, the layout manager module 392 of FIG. 3, or combination thereof.

The creation module 302 can be implemented with the first user interface 218 of FIG. 2, the second user interface 238 of FIG. 2, the first communication unit 216 of FIG. 2, the second communication unit 236 of FIG. 2, the first storage unit 214 of FIG. 2, the second storage unit 246 of FIG. 2, the first control unit 212 of FIG. 2, the second control unit 234 of FIG. 2, or combination thereof.

The valuation module 322 can be coupled to the creation module 302, the transfer module 352, the content updater module 362, the digital rights management (DRM) module 342, the content database module 372, the access control module 382, the layout manager module 392, or combination thereof.

The valuation module 322 can be implemented with the first user interface 218, the second user interface 238, the first communication unit 216, the second communication unit 236, the first storage unit 214, the second storage unit 246, the first control unit 212, the second control unit 234, or combination thereof.

The transfer module 352 can be coupled to the creation module 302, the valuation module 322, the content updater module 362, the digital rights management (DRM) module 342, the content database module 372, the access control module 382, the layout manager module 392, or combination thereof.

The transfer module 352 can be implemented with the first user interface 218, the second user interface 238, the first communication unit 216, the second communication unit 236, the first storage unit 214, the second storage unit 246, the first control unit 212, the second control unit 234, or combination thereof.

The content updater module 362 can be coupled to the creation module 302, the valuation module 322, the transfer module 352, the digital rights management (DRM) module 342, the content database module 372, the access control module 382, the layout manager module 392, or combination thereof.

The content updater module 362 can be implemented with the first user interface 218, the second user interface 238, the first communication unit 216, the second communication unit 236, the first storage unit 214, the second storage unit 246, the first control unit 212, the second control unit 234, or combination thereof.

The digital rights management (DRM) module 342 can be coupled to the creation module 302, the valuation module 322, the transfer module 352, the content updater module 362, the content database module 372, the access control module 382, the layout manager module 392, or combination thereof.

The digital rights management (DRM) module 342 can be implemented with the first user interface 218, the second user interface 238, the first communication unit 216, the second communication unit 236, the first storage unit 214, the second storage unit 246, the first control unit 212, the second control unit 234, or combination thereof.

The content database module 372 can be coupled to the creation module 302, the valuation module 322, the transfer module 352, the content updater module 362, the digital rights management (DRM) module 342, the access control module 382, the layout manager module 392, or combination thereof.

The content database module 372 can be implemented with the first user interface 218, the second user interface 238, the first communication unit 216, the second communication unit 236, the first storage unit 214, the second storage unit 246, the first control unit 212, the second control unit 234, or combination thereof.

The access control module 382 can be coupled to the creation module 302, the valuation module 322, the transfer module 352, the content updater module 362, the digital rights management (DRM) module 342, the content database module 372, the layout manager module 392, or combination thereof.

The access control module 382 can be implemented with the first user interface 218, the second user interface 238, the first communication unit 216, the second communication unit 236, the first storage unit 214, the second storage unit 246, the first control unit 212, the second control unit 234, or combination thereof.

The layout manager module 392 can be coupled to the creation module 302, the valuation module 322, the transfer module 352, the content updater module 362, the digital rights management (DRM) module 342, content database module 372, the access control module 382, the layout manager module 392, or combination thereof.

The layout manager module 392 can be implemented with the first user interface 218, the second user interface 238, the first communication unit 216, the second communication unit 236, the first storage unit 214, the second storage unit 246, the first control unit 212, the second control unit 234, or combination thereof.

The electronic system 100 has been described with module functions or order as an example. The electronic system 100 can partition the modules differently or order the modules differently. For example, the creating module 302 can include the valuation module 322 and the content updater module 362 as separate modules although these modules can be combined into one. Also, the valuation module 322 can be split into separate modules for implementing in the separate modules digital rights management and valuation.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a storage unit configured to implement a creation module for creation of a card;
a control unit, coupled to the storage unit, configured to assign a valuation to the card and
a communication unit, coupled to the control unit, configured to transfer the card.

2. The system as claimed in claim 1 wherein the communication unit is configured to implement a transfer module for a loaning the card.

3. The system as claimed in claim 1 wherein the communication unit is configured to implement a transfer module for borrowing the card.

4. The system as claimed in claim 1 wherein the control unit is configured to recommend an event.

5. The system as claimed in claim 1 wherein the storage unit is configured to implement a creation module for creation of a collection of the cards.

6. The system as claimed in claim 1 wherein the control unit is configured to certify a global positioning system stamp associated with the card.

7. The system as claimed in claim 1 wherein the storage unit is configured to capture a vacation digital footprint.

8. A method of operation of an electronic system comprising:
creating a card;
assigning a valuation, with a control unit, to the card and
transferring the card.

9. The method as claimed in claim 8 wherein transferring the card includes loaning the card.

10. The method as claimed in claim 8 wherein transferring the card includes borrowing the card.

11. The method as claimed in claim 8 further comprising recommending an event.

12. The method as claimed in claim 8 wherein creating a card includes creating a collection of the cards.

13. The method as claimed in claim 8 further comprising certifying a global positioning system stamp associated with the card.

14. The method as claimed in claim 8 further comprising capturing a vacation digital footprint.

15. A non-transitory computer readable medium including stored thereon instructions to be executed by a control unit comprising:
creating a card;
assigning a valuation to the card and
transferring the card.

16. The medium as claimed in claim 15 wherein transferring the card includes loaning the card.

17. The medium as claimed in claim 15 wherein transferring the card includes borrowing the card.

18. The medium as claimed in claim 15 further comprising recommending an event.

19. The medium as claimed in claim 15 wherein creating a card includes creating a collection of the cards.

20. The medium as claimed in claim 15 further comprising certifying a global positioning system stamp associated with the card.
